(19) United States
(12) Patent Application Publication
(10) Pub. No.: US 2025/0314835 A1
(43) Pub. Date: Oct. 9, 2025

(54) LAMINATE PITCH CONVERSION

(71) Applicant: CommScope Technologies LLC, Hickory, NC (US)

(72) Inventors: Scott L. CARLSON, Bloomington, MN (US); Jaime GONZALEZ BATISTA, Prior Lake, MN (US); Connor Thomas WILSON, Maple Grove, MN (US); Seth C. TACCOLA, Lakeville, MN (US); Chinmay M. BENDALE, Eden Prairie, MN (US)

(73) Assignee: CommScope Technologies LLC, Hickory, NC (US)

(21) Appl. No.: 18/865,377

(22) PCT Filed: May 15, 2023
(86) PCT No.: PCT/US2023/022206

§ 371 Date: Nov. 13, 2024

Related U.S. Application Data
(60) Provisional application No. 63/341,729, filed on May 13, 2022.

(51) Int. Cl. G02B 6/36

(52) U.S. Cl. CPC G02B 6/368

(57) ABSTRACT

The present disclosure relates to a laminated fiber assembly that provides pitch conversion between a fiber ribbon having a first pitch (e.g. 200 microns) to a plurality of non-ribbonized fibers having a variable pitch that is larger than the first pitch. The laminated fiber assembly has laminate portion with an adhesive arranged between the non-ribbonized fibers and polymeric sheets arranged on opposing sides of the non-ribbonized fibers of the fiber ribbon.

### CROSS-REFERENCE TO RELATED APPLICATIONS

This application is being filed on May 15, 2023, as a PCT International application and claims the benefit of and priority to U.S. Provisional Application No. 63/341,729, filed May 13, 2022, the disclosure of which is hereby incorporated by reference in its entirety.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances.

Single-mode optical fibers can have a geometry that includes a central core size between 8-10 microns in outer diameter, a cladding layer with an outer diameter of 5 120-130 micrometers (typically about 125 microns), and a coating layer (e.g., acrylate) with an outer diameter in the range of 245-255 microns (typically about 250 microns). Such fibers have been incorporated into fiber ribbons having fibers retained with a center-to-center spacing (i.e., pitch) of about 250 microns. 12-Fiber MT/MPO ferrules including fiber openings having a pitch of about 250 microns have been used with this type of fiber ribbon.

In more recent years, single-mode optical fibers having coatings with outer diameters significantly less than 250 microns (e.g., 200 micron) have become available. Such optical fibers have been incorporated into fiber ribbons having the fibers retained at a pitch significantly less than 250 microns (e.g., about 200 microns).

There is a need for methods and components for facilitating using a fiber optic ribbon having fibers retained at a first pitch with a multi-fiber ferrule having fiber openings arranged at a second pitch that is larger than the first pitch

### SUMMARY

In general terms, this disclosure is directed to laminate pitch conversion. In some embodiments, and by non-limiting example, the laminate pitch conversion converts the pitch of an optical fiber ribbon from a first pitch to a second pitch.

One aspect of the present disclosure relates to a laminated fiber assembly. The laminated fiber assembly comprises a ribbon portion, a fiber portion, and a laminate portion. The ribbon portion includes optical fibers retained at a first pitch. The fiber portion includes the optical fibers arranged at a first variable pitch. The first variable pitch is larger than the first pitch at each point along the first variable pitch. The laminate portion includes the optical fibers, a first polymeric sheet, a second polymeric sheet, and an adhesive. The optical fibers are arranged between the first polymeric sheet and the second polymeric sheet and have a second variable pitch. The second variable pitch is larger than the first pitch, and is smaller than the first variable pitch at each point along the first variable pitch and the second variable pitch.

Another aspect of the present disclosure relates to a method of producing a laminated fiber assembly. The method comprises stripping a ribbonizing material from a ribbonized portion of a fiber ribbon to produce a non-ribbonized portion. The fiber ribbon has a first pitch at the ribbonized portion. The method further comprises applying adhesive to the non-ribbonized portion of the fiber ribbon; applying heat to the non-ribbonized portion of the fiber ribbon; and applying pressure to the non-ribbonized portion of the fiber ribbon. The application of the pressure to the non-ribbonized portion of the fiber ribbon results in the movement of the optical fibers within the non-ribbonized portion of the fiber ribbon away from each other.

Another aspect of the present disclosure relates to a film arrangement. The film arrangement comprises first and second polymeric films arranged in opposition with respect to one another. The film arrangement extends between first and second ends. The film arrangement further comprises a plurality of optical fibers adhesively bound between the first and second polymeric films. The optical fibers extend from the first end to the second end of the film arrangement and are arranged such that a pitch between the fibers varies as the fibers extend between the first and second ends of the film arrangement.

### BRIEF DESCRIPTION OF THE DRAWINGS

FIG. 1 is a top view of an example laminated fiber assembly.

FIG. 2 is a cross sectional view of the example laminate fiber assembly of FIG. 1 along line 1, depicting a ribbon portion of the laminate fiber assembly.

FIG. 3 is a cross sectional view of the example laminate fiber assembly of FIG. 1 along line 2, depicting a ribbonized portion of a fiber ribbon in a laminate portion.

FIG. 4 is a cross sectional view of the example laminate fiber assembly of FIG. 1 along line 3, depicting a non-ribbonized portion of the fiber ribbon in a laminate portion.

FIG. 5 is a cross sectional view of the example laminate fiber assembly of FIG. 1 along line 4, depicting a fiber portion.

FIG. 6 is a flowchart illustrating an example method of making a laminated fiber assembly.

FIG. 7 is a flowchart illustrating an example method of performing the ribbon preparation step of the example method of making a laminated fiber assembly.

FIG. 8 is a flowchart illustrating an example method of performing the pitch up processing step of the example method of making the laminated fiber assembly.

FIG. 9 is a perspective view of a fiber ribbon within a heater during the pitch up processing step of the example method of making the laminated fiber assembly.

FIG. 10 is a flowchart illustrating an example method of performing the post processing step of the example method of making the laminated fiber assembly.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present application relates to a laminated fiber assembly that includes a fiber ribbon having optical fibers arranged at a first pitch, one or more polymeric sheets, and an adhesive. In some embodiments, the polymeric sheets and adhesive are analogous to the flexible polymeric sheets described in PCT Application No. PCT/US2019/052,154, the disclosure of which is hereby incorporated herein by reference in its entirety. The laminated fiber assembly of the present application converts the fibers from the first pitch to a second pitch. The first pitch is smaller than the second pitch, and the polymeric sheets and adhesive provide pitch conversion between the first and second pitches.

In a conventional optical fiber ribbon, coated optical fibers are encapsulated within a volume of matrix material (e.g., acrylate) that acts as a coating and secures the optical fibers in a particular order with the fibers being relatively rigidly held in a planar array at a given location along the length of the ribbon. In other examples, the optical fibers can be secured together via a rollable-ribbon configuration in which relative positioning (e.g., a sequence and pitch) of the optical fibers is established but that the optical fibers are movable relative to one another. Rollable ribbon configurations often provide intermittent connections between the optical fibers, utilize slits in the matrix material to allow the ribbon to be rolled, or use thin layers of matrix material sometimes at only one side of the group of aligned fibers.

Examples of rollable ribbons are disclosed in U.S. Pat. Nos. 10,185,105;9,880,368; 10,488,609; 10,007,078; 9,995,896; 9,086,555; 10,416,403; 9,116,321;10,514,517; 9,989,723, 10,101,549, the disclosures of which are hereby incorporated herein by reference in their entirety. Examples of rollable ribbons also are disclosed in U.S. Publication No. 2020/0271879, the disclosure of which is hereby incorporated herein by reference in its entirety. Other examples of rollable ribbons include the Freeform Ribbon™ produced by Sumitomo of Japan, rollable ribbons produced by OFS Furukawa of Norcross, GA, the SpiderWeb® Ribbon produced by AFL Telecommunications, LLC of Duncan, SC, and FlexRibbon™ of Prysmian Group of Italy.

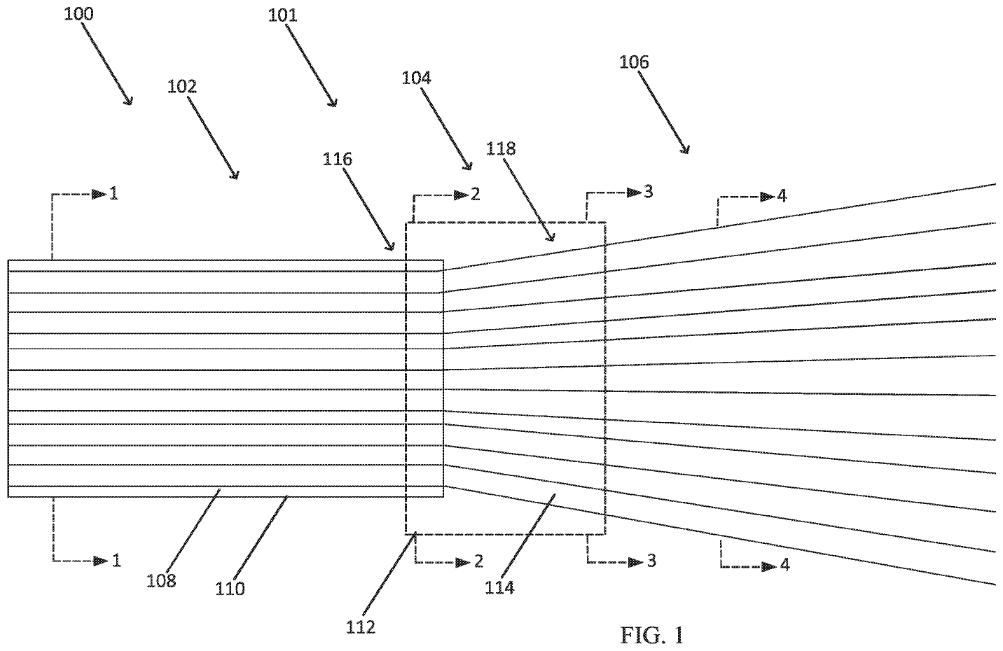

FIG. 1 is a top view of a laminated fiber assembly 100. The laminated fiber assembly 100 includes a fiber ribbon 101. In some examples, the fiber ribbon 101 is processed to form the laminated fiber assembly 100. The fiber ribbon 101 includes a plurality of optical fibers 108. The fiber ribbon 101 also includes a ribbon portion 102, a laminate portion 104, and a fiber portion 106. In some embodiments, the laminate portion 104 is arranged in between the ribbon portion 102 and the fiber portion 106. In some embodiments, the fiber ribbon 101 is a rollable fiber ribbon.

The fiber ribbon 101 includes a ribbonizing material 110. In some embodiments, the ribbonizing material 110 covers the entirety of the fiber ribbon. In other embodiments, the ribbonizing material 110 covers a portion of the fiber ribbon. In some embodiments, the fiber ribbon includes a ribbonized portion 116 and a non-ribbonized portion 118. The ribbonized portion 116 includes the ribbonizing material 110 and the non-ribbonized portion 118 does not include the ribbonizing material 110. In some embodiments, the non-ribbonized portion 118 is produced by stripping off the ribbonizing material 110 from a portion of the fiber ribbon 101.

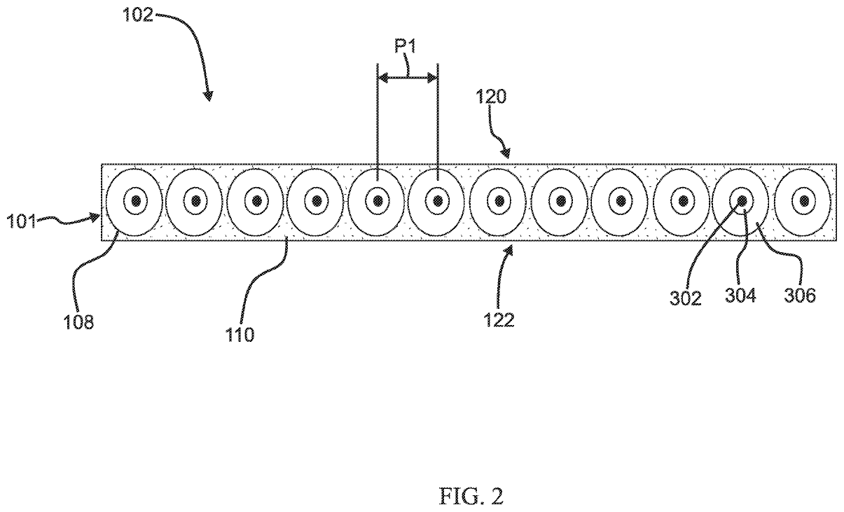

The ribbon portion 102 includes the ribbonized portion 116 of the fiber ribbon 101. The ribbon portion 102 may be arranged in multiple different configurations. In some embodiments, as in the embodiment shown in FIG. 1, the ribbon portion 102 is a 1×12 fiber optic ribbon. In other embodiments, the ribbon portion 102 is configured differently and can be, for example, a 1×16, 2×8, or 2×6 fiber optic ribbon. In some embodiments, the ribbonizing material 110 is a matrix material (e.g., acrylate) that bonds the optical fibers 108 together in a particular order and with a first pitch. The matrix material can include a conventional optical fiber ribbon configuration or a rollable optical fiber ribbon configuration. In some embodiments, the optical fibers 108 in the ribbon portion 102 are arranged at a fixed pitch of about 200 microns (or 200 microns). The ribbon portion 102 is further described with reference to FIG. 2.

The laminate portion 104 includes optical fibers 108 of the fiber ribbon 101. In some embodiments, the laminate portion 104 includes both the ribbonized portion 116 and the non-ribbonized portion 118 of the fiber ribbon 101. In some embodiments, the laminate portion 104 only includes the non-ribbonized portion 118 of the fiber ribbon. In some embodiments, the laminate portion 104 also includes one or more sheets. In some embodiments, the one or more sheets are polymeric sheets 112. In some embodiments, the laminate portion also includes and an adhesive 114.

In some embodiments, the polymeric sheet 112 is positioned below the fiber ribbon 101 within the laminate portion 104, while in other embodiments, the laminate portion 104 is positioned above the fiber ribbon 101 in the laminate portion 104. In some embodiments, the laminate portion 104 includes multiple polymeric sheets 112. In such embodiments, one polymeric sheet 112 is positioned below the fiber ribbon 101 within the laminate portion 104, while another embodiments, the polymeric sheet 112 is positioned above the fiber ribbon 101 in the laminate portion 104. Thus, in some embodiments, the fiber ribbon 101 is sandwiched between the multiple polymeric sheets 112.

As noted above, in some embodiments the laminate portion 104 includes the ribbonized portion 116 and the non-ribbonized portion 118. In some embodiments, the ribbonizing material 110 is completely removed from the optical fibers 108 within the laminate portion 104 such that there is no ribbonized portion 116 within the laminate portion 104. In some embodiments, the optical fibers 108 within the non-ribbonized portion 118 of the fiber ribbon 101 within the laminate portion 104 are not retained at a fixed pitch from the other optical fibers 108 by the ribbonizing material 110. Thus, the optical fibers 108 can move relative to one another to vary the pitch. In some embodiments, as depicted in FIG. 1, the optical fibers 108 within the non-ribbonized portion 118 are arranged so that the optical fibers 108 flare out from one another at an increasing pitch along the length of the laminate portion 104. In some embodiments, the optical fibers 108 flare out from a pitch of about 200 microns (or 200 microns) at the ribbonized portion 116 to a pitch between about 200 to 250 microns (or between 200 to 250 microns) at an end of the laminate portion 104 adjacent to the fiber portion 106.

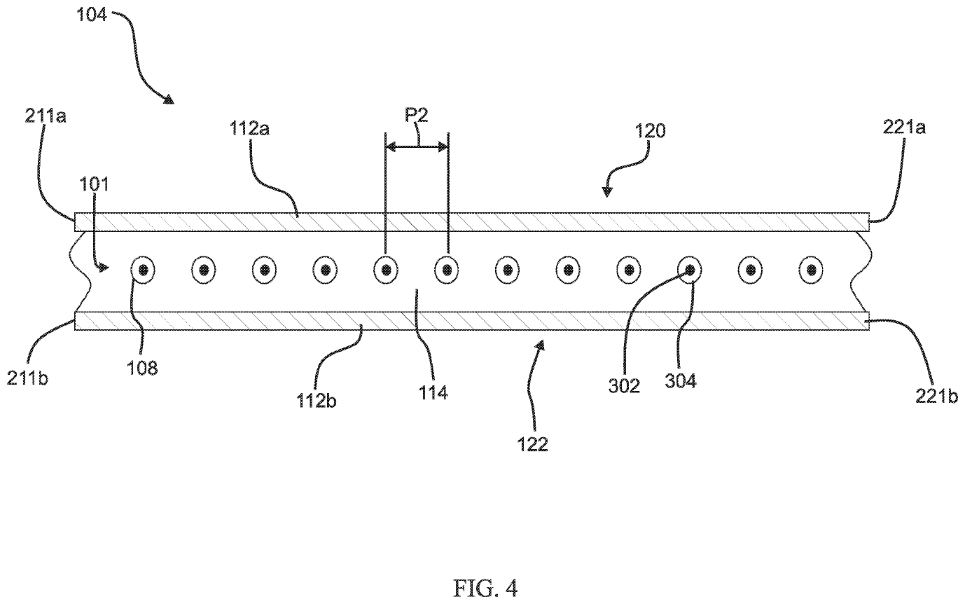

The adhesive 114 is positioned around the optical fibers 108. In some embodiments, the adhesive 114 completely surrounds each optical fiber 108 and fills the voids in between the optical fibers 108 within the non-ribbonized portion 118 of the fiber ribbon 101. In some embodiments, the adhesive 114 is arranged in between the polymeric sheets 112. The laminate portion 104 is further described with reference to FIG. 4.

The fiber portion 106 includes the optical fibers 108 of the fiber ribbon 101. In some embodiments, the ribbonizing material 110 is also removed from the optical fibers 108 within the fiber portion 106. In such embodiments, the fiber portion 106 includes the non-ribbonized portion 118 of the fiber ribbon 101. In such embodiments, the optical fibers 108 within the fiber portion 106 are not retained at a fixed pitch from the other optical fibers 108 by the ribbonizing material 110. In some embodiments, as depicted in FIG. 1, the optical fibers 108 within the fiber portion 106 are arranged so that the optical fibers 108 flare out from one another at an increasing pitch along the length of the fiber portion 106. In some embodiments, at least one point in the fiber portion 106, the optical fibers 108 are spaced from one another at a pitch of about 250 microns (or 250 microns).

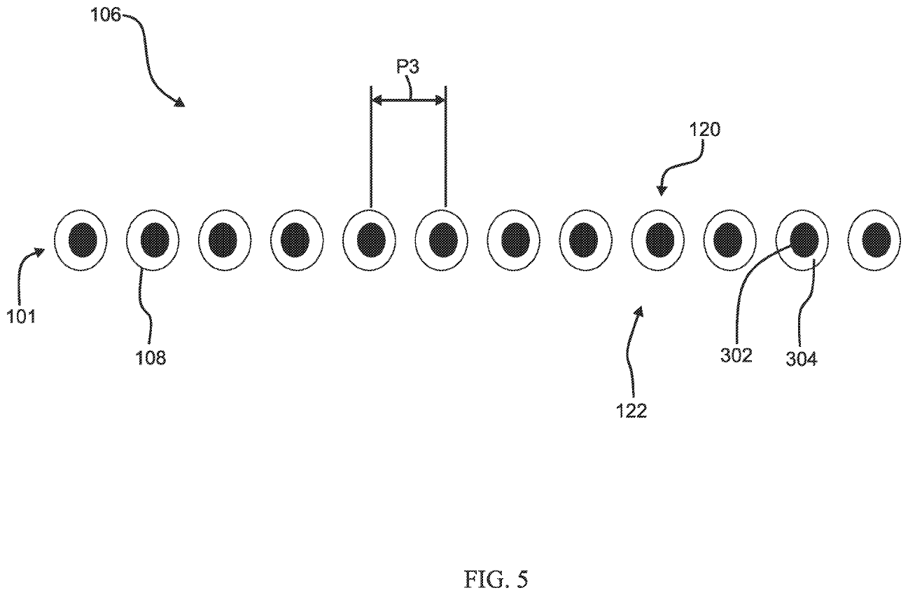

In other embodiments, the optical fiber 108 within the fiber portion 106 can also include a ribbonizing material 110 that retains the optical fibers 108 at a fixed pitch from one another. In some embodiments, the ribbonizing material 110 within the fiber portion 106 retains the optical fibers 108 at a pitch of about 200 microns (or 200 microns). The fiber portion 106 is further described with reference to FIG. 5.

In some embodiments, the optical fiber ribbon 101 remains flat along the length of the ribbon portion 102, the laminate portion 104, and the fiber portion 106, so that a portion of the ribbon portion 102, the laminate portion 104, and the fiber portion 106 is coplanar with each other.

FIG. 2 is a cross sectional view of the ribbon portion 102. As shown in FIG. 2 and referenced above, the ribbon portion 102 includes the optical fibers 108, and the ribbonizing material 110. In some embodiments, the ribbon portion 102 is a rollable ribbon. In some embodiments, the ribbon portion 102 is formed from a controlled glue stick ribbonizer. As depicted in the embodiment of FIG. 2, the ribbon portion 102 includes 12 optical fibers 108, however in other embodiments, the ribbon portion 102 includes any number of optical fibers 108, such as 4, 8, 16, or 18 optical fibers 108.

In some embodiments, the optical fibers 108 each comprise a core 302 made of a light transmissive material such as glass, a cladding layer 304 surrounding the core 302 made of a material having a lower index of refraction as compared to the material of the core, and a polymeric coating material layer 306 (e.g., acrylate) surrounding the cladding layer 304. In one example, the core can have a diameter ranging from 5-15 microns, the cladding layer 304 can have an outer diameter ranging from 120-130 microns, and the coating layer 306 can have an outer diameter less than 210 microns (e.g., about 200 microns).

In some embodiments, the ribbonized portion 116 of the fiber ribbon 101 includes a ribbonizing material 110. In some embodiments, the ribbonizing material 110 is made from the same material as the polymeric coating layer 306. The ribbonizing material 110 of the fiber ribbon 101 retains the optical fibers 108 adjacent to one another at a fixed pitch. In some embodiments, the ribbonizing material 110 retains the plurality of optical fibers 108 at a first pitch corresponding to the first center-to-center spacing P1. The center-to-center spacing can correspond to the coating diameters of the optical fibers 108 (e.g., less than 210 microns, or about 200 microns).

In some embodiments, the optical fibers 108 in the fiber ribbon 101 within the ribbon portion 102 are arranged in a row. Each row has a first major side 120 and an opposite second major side 122 that extend across the optical fibers 108 in the row.

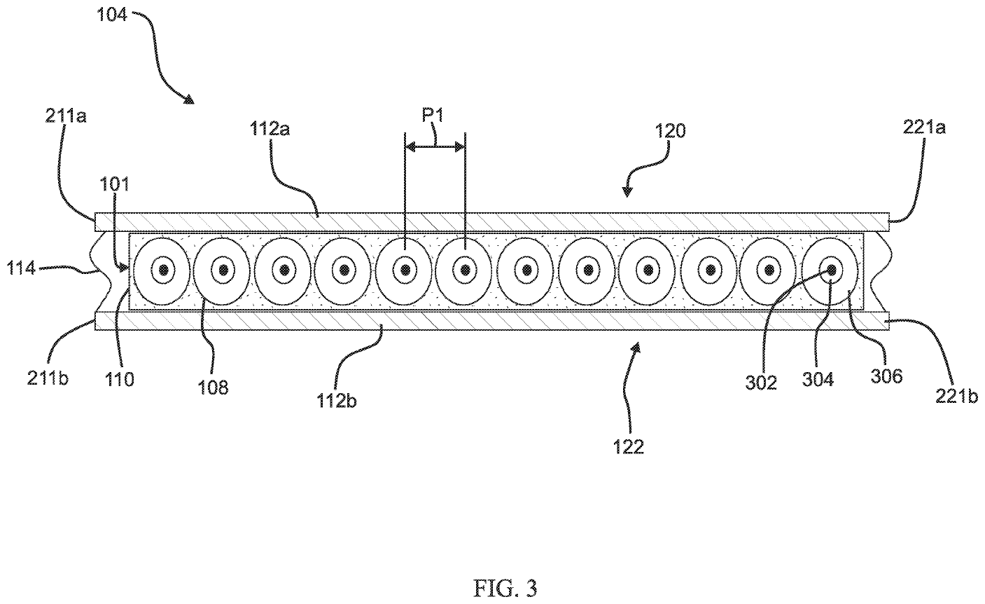

FIGS. 3 and 4 are cross sectional views of the example laminate fiber assembly 100 of FIG. 1. As noted above, in some embodiments, the laminate portion 104 includes both the ribbonized portion 116 and the non-ribbonized portion 118 of the fiber ribbon 101. In other embodiments, the laminate portion 104 includes only the non-ribbonized portion 118 of the fiber ribbon 101. FIG. 3 is a cross sectional view of the ribbonized portion 116 of the fiber ribbon 101 positioned within the laminate portion 104. FIG. 4 is a cross sectional view of the non-ribbonized portion 118 of the fiber ribbon 101 positioned within the laminate portion 104.

FIG. 3 is a cross sectional view of the example laminate fiber assembly 100 of FIG. 1 along line 2, depicting the ribbonized portion 116 of the fiber ribbon 101 in the laminate portion 104. As shown in FIG. 1 and referenced above, in some embodiments, the laminate portion 104 includes the fiber ribbon 101, a polymeric sheet 112, and an adhesive 114. In some embodiments, the laminate portion 104 includes multiple polymeric sheets 112, such as a top polymeric sheet 112a and a bottom polymeric sheet 112b.

As depicted in FIG. 3, the fiber ribbon 101 is substantially the same as the fiber ribbon 101 of the ribbon portion 102, depicted in FIG. 2. In some embodiments, due to the presence of the ribbonizing material 110 that retains the optical fibers 108 at a fixed pitch, the pitch of the optical fibers 108 within the ribbonized portion 116 in the laminate portion 104 has the same pitch P1 as the pitch of the fiber ribbon 101 in the ribbon portion 102. In FIG. 3, however, the fiber ribbon 101 also includes a top and bottom polymeric sheet arranged at a top and bottom side of the fiber ribbon 101 and the adhesive. 114. The arrangement of the fibers 108, polymeric sheets 112, and the adhesive 114 within the laminate portion 104 are described in further detail with reference to FIG. 4.

FIG. 4 is a cross sectional view of the example laminate fiber assembly 100 of FIG. 1 along line 3, depicting the ribbonized portion 116 of the fiber ribbon 101 in the laminate portion 104. As shown in FIG. 1 and referenced above, in some embodiments, the laminate portion 104 includes the fiber ribbon 101, a polymeric sheet 112, and an adhesive 114. In some embodiments, the laminate portion 104 includes multiple polymeric sheets 112, such as a top polymeric sheet 112a and a bottom polymeric sheet 112b.

As depicted in FIG. 4, in some embodiments, the ribbonizing material 110 is removed from the fiber ribbon 101 along a portion of the length of the fiber ribbon 101 that is arranged within the laminate portion 104. In some embodiments, as depicted in FIG. 4, the coating layer 306 may also be removed from the optical fibers 108 along a portion of the length of the fiber ribbon 101 that is arranged within the laminate portion. In some embodiments, the adhesive 114 directly contacts the cladding 304 of the optical fiber 108.

In some embodiments, the optical fibers 108 within the laminate portion 104 are arranged in a row with a first major side 120 and an opposite second major side 122 that extend across the optical fibers 108 in the row.

In some examples, the top polymeric sheet 112a is applied to the first major side 120 and the bottom polymeric sheet 112b is applied to the second major side 122 of each row.

In some examples, the polymeric sheets 112 also include the adhesive 114. In some examples, the adhesive 114 is a heat activated adhesive layer carried by the polymeric sheet 112. The adhesive layer on the top polymeric sheet 112a is bonded to the first major sides 120 of the fiber ribbon 101 and the adhesive layer on the bottom polymeric sheet 112b is bonded to the second major side 122 of the fiber ribbon 101.

In some embodiments, the polymeric sheets 112 each have a thickness in the range of 0.003 to 0.02 inches.

In some embodiments, the polymeric sheets 112 each have a thickness less than or equal to 0.02 inches, or less than or equal to 0.01 inches, or less than or equal to 0.005 inches.

In some embodiments the polymeric sheets 112 are wider than the fiber ribbon 101. In some examples, the polymeric sheets 112 are adhesively bonded to each other at longitudinal edges 211a, 221a, 211b, 221b that are positioned along outer longitudinal edges of the fiber ribbon 101.

In some embodiments, the polymeric sheets 112 are approximately as flexible as the fiber ribbon 101.

In some embodiments, the polymeric sheets 112 have a first flexibility. The ribbonized portion 116 of the fiber ribbon 101 has a second flexibility. The first and second flexibilities do not vary by more than 25 percent.

In some embodiments, the heat activated adhesive 114 can be activated in an oven.

In some embodiments, the polymeric sheets 112 include mylar.

In some embodiments, the adhesive 114 in the adhesive layers is heat activated. In some embodiments, the adhesive 114 bonds to the fibers upon the application of a predetermined amount of heat. In other embodiments, the adhesive 114 in the adhesive layers is pressure activated. The adhesive 114 bonds to the fibers upon the application of a predetermined amount of pressure applied to the adhesive 114 via the polymeric sheets 112. In still other embodiments, the adhesive 114 in the adhesive layers is UV curable. The adhesive 114 bonds to the fibers when exposed to a predetermined amount of UV light. In yet still other embodiments, the adhesive 114 that is formed as adhesive layers on the polymeric sheets 112 are covered in a protective backing that can be peeled off or otherwise removed from the adhesive layers to expose the adhesive 114. In such embodiments, the adhesive 114 may bond to the upon contact without added heat, light, or pressure. In some embodiments, no chemicals are needed to activate the adhesive 114.

In some embodiments, the adhesive 114 formed as adhesive layers on the polymeric sheets 112 varies in thickness over an axial length and/or a lateral width of the polymeric sheets 112. For example, the adhesive layer may be thicker around the non-ribbonized portion 118 of the optical fibers 108 than around the ribbonized portion 116. In other embodiments, the adhesive layers may have a consistent thickness over the axial length. In still other embodiments, one of the adhesive layers may have a different thickness than the other adhesive layer.

In some embodiments, the pitch of the optical fibers 108 within the laminate portion 104 is measured by the second center-to-center spacing P2. In some embodiments, the second center-to-center spacing ranges between about 200 microns and 250 microns (or 200-250 microns) along the length of the laminate portion 104. In some embodiments, the second center-to-center spacing P2 is larger than the first center-to-center spacing P1.

FIG. 5 is a cross sectional view of the fiber portion 106. The fiber portion 106 includes the optical fibers 108 of the fiber ribbon 101. The fiber portion 106 includes the non-ribbonized portion 118 of the fiber ribbon 101. Because the optical fibers 108 within the fiber portion 106 lack the ribbonizing material 110, the optical fibers 108 are free to move relative to one another at a varying pitch. In some embodiments, the pitch of the optical fibers 108 within the fiber portion 106 remains constant along the length of the fiber portion 106. In other embodiments, the pitch of the optical fibers 108 within the fiber portion 106 increases along the length of the fiber portion 106, moving away from the laminate portion 104. In some embodiments, the pitch of the optical fibers 108 is measured by the third center-to-center spacing P3. In some embodiments, the third center-to-center spacing is about 250 microns (or 250 microns) at a point along the length of the fiber portion 106. In some embodiments, the third center-to-center spacing P3 is larger than the second center-to-center spacing P2 and the first center-to-center spacing P1.

In some embodiments, the optical fibers 108 within the fiber portion 106 also have the coating layer 306 removed from the optical fibers 108.

In some embodiments, the optical fibers 108 within the fiber portion 106 are arranged in a row with a first major side 120 and an opposite second major side 122 that extends across the optical fibers 108 in the row.

In some embodiments, the fiber portion 106 is inserted into a ferrule or spliced to other optical fibers 108. In some embodiments, a portion of the fiber portion 106 may also include a ribbonizing material 110 applied thereto.

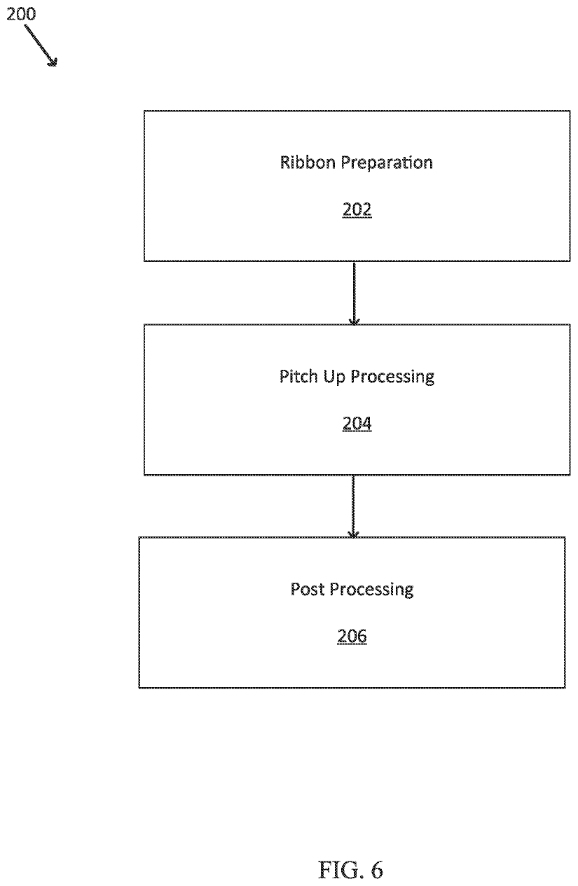

FIG. 6 is a flow chart illustrating an example method 200 of making a laminated fiber assembly 100. In this example, the method 200 includes the ribbon preparation operation 202, the pitch up processing operation 204, and the post processing operation 206.

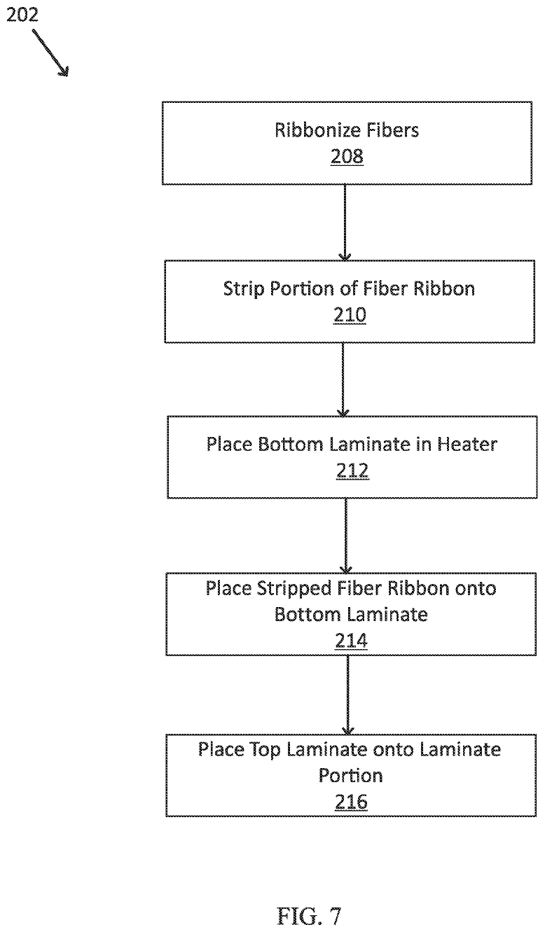

FIG. 7 is a flow chart illustrating an example method of performing the ribbon preparation operation 202 of the method 200 of making the laminated fiber assembly 100. In this example, the method 202 includes operations 208, 210, 212, 214, and 216.

Operation 208 includes ribbonizing the optical fibers 108. In operation 208, the fiber ribbon 101 is formed by applying the ribbonizing material 110 to a plurality of optical fibers 108. In some examples, the ribbonizing the optical fibers 108 operation 208 includes forming a fiber ribbon 101 with a pitch of about 200 microns (or 200 microns). In some examples, the operation 208 is performed with a controlled glue stick ribbonizer with a sorter. Completion of operation 208 results in the fiber ribbon 101 with a ribbonized portion 116 along the length of the fiber ribbon 101.

Operation 210 includes stripping a portion of the fiber ribbon 101. In operation 210, the ribbonizing material 110 of the fiber ribbon 101 is removed from a portion of the fiber ribbon 101 to separate the optical fibers 108. Thus, performance of operation 210 produces a non-ribbonized portion 118 along the length of the fiber ribbon 101. In some examples, operation 210 is performed with an automated stripper. In some examples, operation 210 further includes removing a portion of the coating layer 306 of the optical fibers 108.

Operation 212 includes loading the bottom polymeric sheet 112b into a heater. In some examples, the bottom polymeric sheet 112b must be cut to a specified shape before loading into the heater.

Operation 214 includes placing the stripped fiber ribbon 101 from operation 210 onto the bottom polymeric sheet 112b. In some examples, only the non-ribbonized portion 118 is placed onto the bottom polymeric sheet 112b. In other examples, both a portion of the ribbonized portion 116 and the non-ribbonized portion 118 are placed onto the bottom polymeric sheet 112b.

Operation 216 includes loading the top polymeric sheet 112a onto the stripped fiber ribbon 101. In some examples, the top polymeric sheet 112a is cut to a specified shape before loading into the heater. In some examples, the top polymeric sheet 112a is cut to the same shape as the bottom polymeric sheet 112b before loading into the heater. In some examples, the top polymeric sheet 112a is placed on top of the fiber ribbon 101 at the same location along the length of the fiber ribbon 101 as the bottom polymeric sheet 112b.

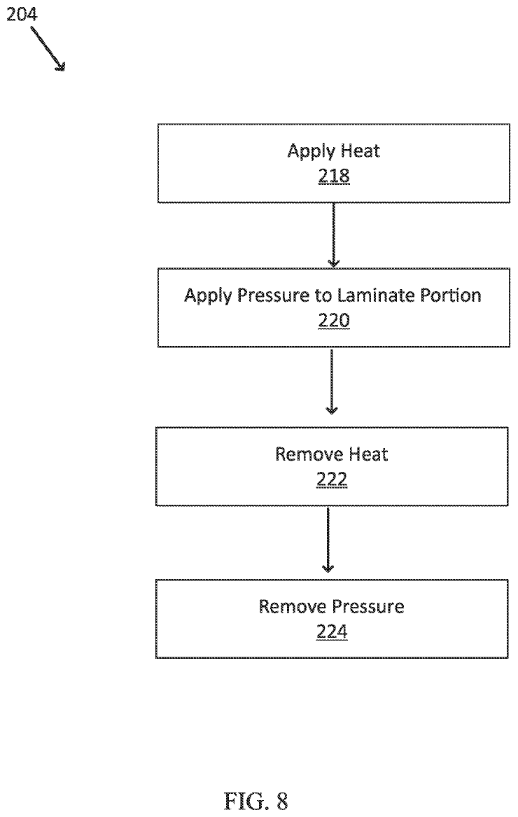

FIG. 8 is a flow chart illustrating a method of performing the pitch up processing operation 204 of the method 200 of making the laminated fiber assembly 100. In this example, the method 204 includes operations 218, 220, and 222.

Operation 218 involves applying heat to the fiber ribbon 101 and the polymeric sheets 112. In some examples, heat is applied by the heater. In other examples, heat is applied by a heat gun, an oven, or other methods. In some examples, the fiber ribbon 101 and polymeric sheets 112 are heated to a temperature sufficient to activate a heat activated adhesive 114. In some examples, the fiber ribbon 101 and polymeric sheets 112 are heated to a temperature of approximately 118° F. or higher. In some examples, once the heat activated adhesive 114 is heated to a sufficient temperature, it liquifies to a point where it is able to flow around the portion of the optical fibers 108 positioned between the polymeric sheets 112.

In some examples, the amount of heat can be adjusted to optimize the ability of the adhesive 114 to flow around the optical fibers 108. In some examples, the length of time for which the heat is provided can be adjusted to optimize the ability of the adhesive 114 to flow around the optical fibers 108.

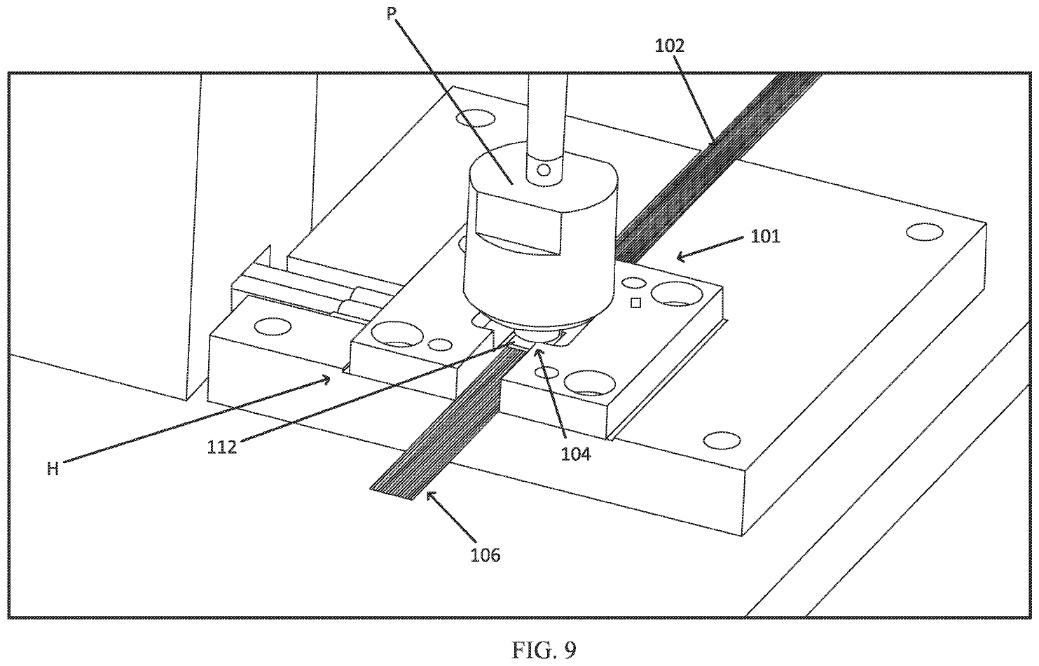

FIG. 9 is a perspective view of the fiber ribbon 101 within the heater during the performance of operation 220. Operation 220 includes applying pressure to the laminate portion 104. In some examples, as depicted in FIG. 9, the fiber ribbon 101 is loaded into the heater H so that the ribbon portion 102 and the fiber portion 106 extend out of the heater H and the laminate portion 104 contacts the heater H. Once heat is applied to the laminate portion 104 of the fiber ribbon 101, pressure is applied to the laminate portion 104 in operation 220. In some examples, pressure is applied to the laminate portion 104 by a piston P that contacts a polymeric sheet 112 in the laminate portion 104. In some examples, the piston P contacts the top polymeric sheet 112a while the bottom polymeric sheet 112b is supported by a base of the heater H. In some examples, the base of the heater His a heating element that directly contacts and supports the bottom polymeric sheet 112b.

In some examples, as the pressure is applied to the laminate portion 104, the adhesive 114 flows between the optical fibers 108 and pushes the optical fibers 108 apart from each other. Thus, the application of pressure to the laminate portion 104 results in the movement of the optical fibers 108 apart from each other. In some examples, the movement of the optical fibers 108 apart from each other only occurs within the non-ribbonized portion 118 of the fiber ribbon 101 due to the fact that the ribbonizing material 110 in the ribbonized portion 116 of the fiber ribbon 101 retains the optical fibers 108 at a fixed distance from each other. Because the optical fibers 108 within the ribbonized portion 116 are held at a fixed distance from each other and the optical fibers 108 within the non-ribbonized portion 118 are pushed away from each other, the performance of operation 220 results in the flaring arrangement of the optical fibers 108 so that the pitch of the optical fibers 108 increases along the length of the non-ribbonized portion 118.

In some examples, the pressure applied by the piston P can be adjusted to vary the amount that the adhesive 114 pushes the optical fibers 108 away from each other. In some examples, the amount of time for which the pressure is applied can be adjusted to vary the amount the adhesive 114 pushes the optical fibers 108 away from each other.

Referring back to FIG. 8, operation 222 involves removing heat from the laminate portion 104. In some examples, operation 222 is performed as pressure is applied to the laminate portion 104 by the piston P. In some examples, when operation 222 is performed to remove the heat, the adhesive 114 cures and solidifies. When the adhesive 114 solidifies, it stops pushing the optical fibers 108 further apart from each other. In some examples, the solidification of the adhesive 114 locks the optical fibers 108 into place. In some examples, the adhesive 114 locks the optical fibers 108 into place in the flared arrangement. In some examples, the solidification of the adhesive 114 also locks the polymeric sheets 112 to the fiber ribbon 101. In some examples, the polymeric sheets are adhered to the fiber ribbon 101 by the adhesive 114. In some examples, the polymeric sheets are adhered to each other by the adhesive 114.

Operation 224 involves removing the pressure from the laminate portion 104. In some examples, operation 224 involves removing the piston P from contact with the laminate portion 104. In some examples, operation 224 is performed before operation 222 so that the pressure is removed from the laminate portion 104 before the heat is removed.

In some examples, such as when a pressure activated adhesive 114 is used, operations 218 and 222 are omitted from the method 204. In these examples, the application of pressure alone to the laminate portion 104 is sufficient to activate the adhesive 114 and allow the adhesive 114 to push the optical fibers 108 into the flared arrangement. The removal of pressure from the laminate portion 104 results in the curing and solidification of the adhesive 114, which locks the optical fibers 108 into place.

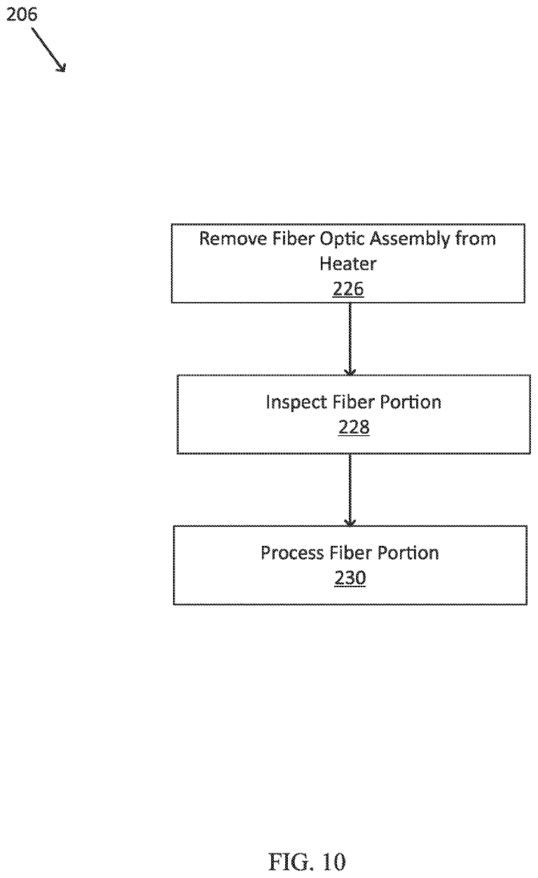

FIG. 10 is a flow chart illustrating a method of performing the post processing operation 206 of the method 200 of making the laminated fiber assembly 100. In this example, the method 204 includes operations 226, 228, and 230.

Operation 226 involves removing the laminated fiber assembly 100 from the heater H. In operation 226, the fiber ribbon 101 and the polymeric sheets 112 are removed as a single assembly.

Operation 228 involves inspecting the fiber portion 106. In some examples, operation 228 is performed to ensure that the optical fibers 108 within the fiber portion 106 are arranged at a desired pitch. In some examples, operation 228 involves visually inspecting the fiber portion 106 with a microscope and measuring spaces between the optical fibers 108. In some examples, operation 228 involves placing the optical fibers 108 into a fixture to ensure proper spacing between the optical fibers 108.

In some examples, if the operation 228 is performed and the fiber portion 106 is determined to not have the desired pitch, operation 204 can be performed again so that the optical fibers 108 can be arranged at the desired pitch. In some examples, operation 204 can be performed multiple times until the optical fibers 108 reach the desired arrangement.

Operation 230 involves processing the fiber portion 106. In some examples, once a point on the fiber portion 106 is identified as having a desired pitch, operation 230 is performed to cleave the optical fibers 108 at the point on the fiber portion 106 with the desired pitch. In such examples, the cleaved end of the fiber portion 106 will have the desired pitch.

In other examples, portions of operation 230 are performed before operation 213 as part of the ribbon preparation operation 202. In such examples, the fiber portion 106 is pre-cleaved. In such examples, pressure is applied to the laminate portion 104 in operation 220 until the pre-cleaved ends are arranged at a desired pitch.

In some examples, operation 230 involves inserting the ends of the optical fibers 108 into a ferrule. In some examples, the ends of the optical fibers 108 are cut at a point where the optical fibers 108 are arranged with a pitch of about 250 microns (or 250 microns). In such examples, the ends of the optical fibers 108 can be inserted into a ferrule with openings at a pitch of about 250 microns (or 250 microns).

In some examples, operation 230 involves splicing the ends of the optical fibers 108 to the ends of other optical fibers 108 within another fiber ribbon 101. In some examples, the ends of the other optical fibers 108 within the other fiber ribbon are arranged at a pitch of about 250 microns (or 250 microns). In such examples, the ends of the optical fibers 108 of the laminated fiber assembly 100 can be cut at a point where the fibers are arranged with a pitch of about 250 microns (or 250 microns).

In some examples, operation 230 can further involve placing a boot around a portion of the fiber portion 106. In some examples, the boot extends around the laminate portion 104. In some examples, the boot extends around the polymeric sheets 112.

In some examples, operation 230 involves applying a ribbonizing material over a portion of the non-ribbonized portion 118 of the optical fibers 108 within the fiber portion 106. In some examples, the ribbonizing material is applied at a point on the fiber portion 106 where the optical fibers 108 are arranged at a desired pitch. In such examples, the ribbonizing material serves to retain the optical fibers 108 of the fiber portion 106 at the desired pitch.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. A laminated fiber assembly comprising:
a ribbon portion including optical fibers retained at a first pitch;
a fiber portion in which the optical fibers are arranged having a first variable pitch, the first variable pitch being larger than the first pitch at each point along the first variable pitch;
a laminate portion including:
the optical fibers;
a first polymeric sheet;
a second polymeric sheet; and
an adhesive;
the optical fibers being arranged between the first polymeric sheet and the second polymeric sheet and having a second variable pitch, the second variable pitch being larger than the first pitch, and being smaller than the first variable pitch at each point along the first variable pitch and the second variable pitch.

2. The laminated fiber assembly of claim 1, wherein the first polymeric sheet is adhesively bound to the optical fibers.

3. The laminated fiber assembly of claim 2, wherein the second polymeric sheet is adhesively bound to the optical fibers.

4. The laminated fiber assembly of claim 3, wherein the laminate portion is arranged between the ribbon portion and the fiber portion.

5. The laminated fiber assembly of claim 3, wherein the adhesive is arranged between the first polymeric sheet and the second polymeric sheet.

6. The laminated fiber assembly of claim 5, wherein the adhesive is arranged between the optical fibers within the laminate portion.

7. The laminated fiber assembly of claim 1, wherein the ribbon portion includes a ribbonizing material around the optical fibers, wherein the ribbonizing material is stripped from the optical fibers in the fiber portion and the laminate portion.

8. The laminated fiber assembly of claim 7, wherein a portion of the ribbonizing material is arranged within the laminate portion.

9. The laminated fiber assembly of claim 7, wherein the optical fibers in the fiber portion have a pitch of about 250 microns at a point along the length of the fiber portion.

10. A method of producing a laminated fiber assembly, the method comprising:
stripping a ribbonizing material from a ribbonized portion of a fiber ribbon to produce a non-ribbonized portion, the fiber ribbon having a first pitch at the ribbonized portion;
applying adhesive to the non-ribbonized portion of the fiber ribbon;
applying heat to the non-ribbonized portion of the fiber ribbon; and
applying pressure to the non-ribbonized portion of the fiber ribbon;
wherein the application of the pressure to the non-ribbonized portion of the fiber ribbon results in the movement of optical fibers within the non-ribbonized portion of the fiber ribbon away from each other.

11. The method of claim 10, further comprising:
removing the heat from the non-ribbonized portion of the fiber ribbon; and
removing the pressure from the non-ribbonized portion of the fiber ribbon.

12. The method of claim 11, wherein the amount of pressure applied to the non-ribbonized portion of the fiber ribbon is controlled to move the optical fibers in the non-ribbonized portion to a second pitch at a point along a length of the non-ribbonized portion.

13. The method of claim 12, wherein the second pitch is greater than the first pitch.

14. The method of claim 13, wherein the first pitch is 200 microns.

15. The method of claim 14, wherein the second pitch is 250 microns.

16. The method of claim 10, further comprising placing a first polymeric sheet below the non-ribbonized portion of the fiber ribbon.

17. The method of claim 16, further comprising placing a second polymeric sheet above the non-ribbonized portion of the fiber ribbon.

18. The method of claim 17, wherein the heat is applied to the non-ribbonized portion through one or more of the polymeric sheets.

19. The method of claim 18, wherein the pressure is applied to the non-ribbonized portion through one or more of the polymeric sheets.

20. A film arrangement comprising:
first and second polymeric films arranged in opposition with respect to one another, the film arrangement extends between first and second ends; and
a plurality of optical fibers adhesively bound between the first and second polymeric films;
the optical fibers extending from the first end to the second end of the film arrangement and being arranged such that a pitch between the optical fibers varies as the optical fibers extend between the first and second ends of the film arrangement.
